(19) United States
(12) Patent Application Publication
(10) Pub. No.: US 2020/0268146 A1
(43) Pub. Date: Aug. 27, 2020

(54) APPARATUS FOR ACCOMMODATING A COMPUTER

(71) Applicant: Alcon Inc., Fribourg (CH)

(72) Inventor: David Buege, Potsdam (DE)

(21) Appl. No.: 16/789,714

(22) Filed: Feb. 13, 2020

Related U.S. Application Data
(60) Provisional application No. 62/808,575, filed on Feb. 21, 2019.

(51) Int. Cl. A47B 21/06; G06F 1/16

(52) U.S. Cl. CPC A47B 21/06; G06F 1/1632; A47B 2200/0066; A47B 2200/0082; A47B 2021/066

(57) ABSTRACT

In certain embodiments, an apparatus for accommodating a computer includes a horizontal platform, docking station, and cable pathway. The horizontal platform can support a medical device. The horizontal platform has an upper surface and a rectangular recessed portion. The docking station is disposed at least partially within the recessed portion, and can connect to either a first or second computer. Each computer has a top surface and can be in an open or closed state. The cable pathway between the medical device and docking station can accommodate cables that connect the medical device to the docking station. The recessed portion can accommodate either the first or second computer when either the first or second computer is connected to the docking station, such that the top surface of the accommodated computer is level with the upper surface of the horizontal platform when the computer is in the closed state.

### TECHNICAL FIELD

The present disclosure relates generally to workstation furniture, and more specifically to an apparatus for accommodating a computer.

### BACKGROUND

Certain medical devices can be connected to a computer to allow for communication between the computer and medical device. The computer may provide user input, motion commands, and instructions to the medical device, and the medical device may provide measurement results to the computer. With the advent of smaller, lighter computers, such as laptops, an operator of the medical device can bring the computer to the medical device, connect the computer to use the medical device, and then disconnect the computer when finished using the device. The operator may then take the computer to another place to, e.g., review the results, which allows another operator to use the medical device.

### BRIEF SUMMARY

In certain embodiments, an apparatus for accommodating a computer of multiple computers includes a horizontal platform, a first docking station, and a cable pathway. The horizontal platform is supported by legs and can support a medical device. The horizontal platform has an upper surface and a rectangular recessed portion. The first docking station is disposed at least partially within the rectangular recessed portion, and can connect to either a first computer or a second computer. Each computer has a top surface and can be in an open state or a closed state. The cable pathway is disposed between the medical device and the docking station, and can accommodate one or more cables that connect the medical device to the first docking station. The rectangular recessed portion can accommodate either the first computer or the second computer when either the first computer or the second computer is connected to the docking station, such that the top surface of the accommodated computer is level with the upper surface of the horizontal platform when the computer is in the closed state.

In certain embodiments, a method for accommodating a computer of a plurality of computers includes supporting a medical device with a horizontal platform supported by a plurality of legs. The horizontal platform has an upper surface and a rectangular recessed portion. A first docking station is disposed at least partially within the rectangular recessed portion. The first docking station can connect to either a first computer of the plurality of computers or to a second computer of the plurality of computers. Each computer of the plurality of computers has a top surface, and can be in an open state or a closed state. One or more cables are accommodated in a cable pathway from the medical device to the docking station. The one or more cables connect the medical device to the first docking station. The rectangular recessed portion can accommodate either the first computer or the second computer when either the first computer or the second computer is connected to the docking station, such that the top surface of the accommodated computer is level with the upper surface of the horizontal platform when the computer is in the closed state.

Embodiments of the apparatuses and methods may include one, two, or more of any of the following features:
The first computer and the second computer are the same size.
The first computer is of a different size than that of the second computer.
One or more inserts, where an insert is configured to adjust the position of the accommodated computer such that the top surface of the accommodated computer is level with the upper surface of the horizontal platform.
One or more inserts, where an insert is configured to adjust the position of the accommodated computer such that the top surface of the accommodated computer is level with the upper surface of the horizontal platform. The insert can have a shape, such as a rectangular cuboid, a wedge shape, and a trapezoidal cuboid.
A second docking station, where the one or more cables are configured to connect the medical device to the second docking station when the first docking station is not connected to the one or more cables.
A second docking station, where the one or more cables are configured to connect the medical device to the second docking station when the first docking station is not connected to the one or more cables, and the first docking station and the second docking station are the same size.
A second docking station, where the one or more cables are configured to connect the medical device to the second docking station when the first docking station is not connected to the one or more cables, and the first docking station is of a different size than that of the second docking station.
One or more inserts, where an insert is configured to adjust the position of the first docking station such that the top surface of the accommodated computer is level with the upper surface of the horizontal platform.
A computer can be a laptop, a tablet computer, or mobile phone.
The horizontal platform supported by the legs form a table, where the legs rest upon a floor.
The horizontal platform supported by the legs form a table extending from a wall, where the legs are angled supports that couple the horizontal platform to the wall.
The horizontal platform supported by the legs are part of a lift table, where manual action or a mechanized motor can engage the legs to raise or lower the horizontal platform.

### BRIEF DESCRIPTION OF THE DRAWINGS

Embodiments of the present disclosure are described by way of example in greater detail with reference to the attached figures, in which:

FIGS. 1 to 3 illustrate an apparatus for accommodating a computer of a plurality of computers:

FIG. 1 illustrates a side view of the apparatus;

FIG. 2 illustrates a front view of the apparatus; and

FIG. 3 illustrates a top view of the apparatus.

FIGS. 4A and 4B illustrate examples of an insert that can be used with the apparatus of FIG. 1.

### DESCRIPTION OF EXAMPLE EMBODIMENTS

Referring now to the description and drawings, example embodiments of the disclosed apparatuses, systems, and methods are shown in detail. As apparent to a person of ordinary skill in the field, the disclosed embodiments are exemplary and not exhaustive of all possible embodiments.

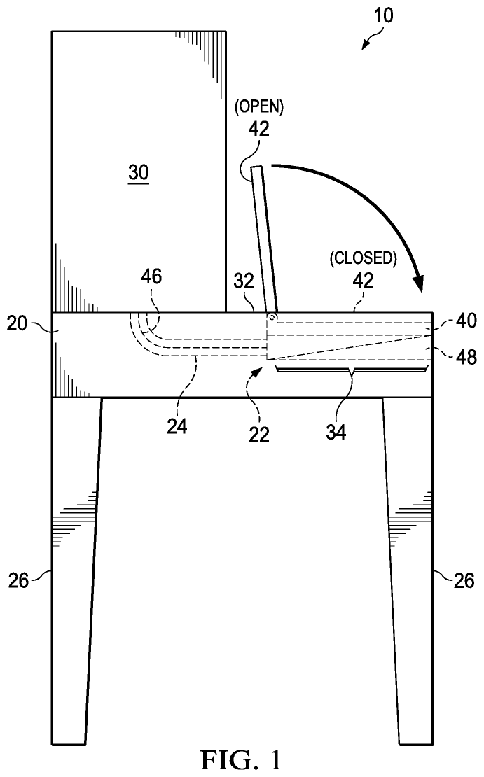

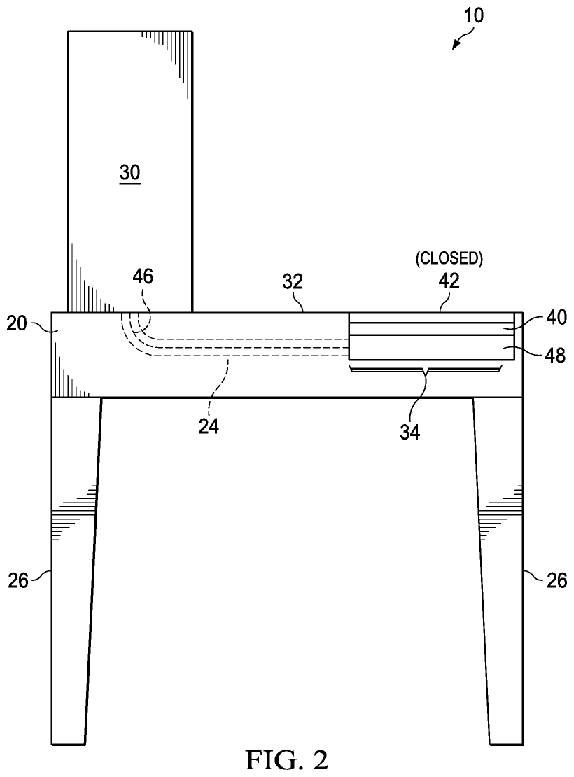

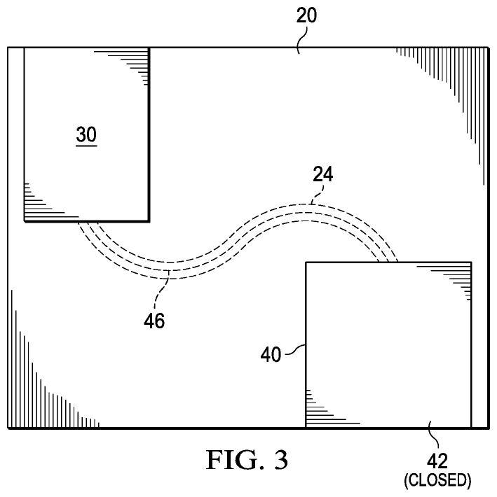

FIGS. 1 to 3 illustrate an apparatus 10 for accommodating a computer of a plurality of computers. FIG. 1 illustrates a side view of apparatus 10; FIG. 2 illustrates a front view of apparatus 10; and FIG. 3 illustrates a top view of apparatus 10.

In the illustrated example, an apparatus 10 comprises a horizontal platform 20, a docking station 22, and a cable pathway 24. Horizontal platform 20 is supported by legs 26 and in turn supports a medical device 30. Horizontal platform 20 has an upper surface 32 and a rectangular recessed portion 34. Docking station 22 is located at least partially within rectangular recessed portion 34. Docking station 22 connects to either a first computer 40 of the plurality of computers or to a second computer 40 of the plurality of computers. Each computer 40 has a top surface 42 and can be in an open state or a closed state. Cable pathway 24 is located between medical device 30 and docking station 22. Cable pathway 24 accommodates one or more cables 46 that connect medical device 30 to docking station 22. Rectangular recessed portion 34 accommodates either the first computer 40 or the second computer 40 when either computer 40 is connected to docking station 22, such that top surface 42 of the accommodated computer 40 is level with upper surface 32 of horizontal platform 20 when computer 40 is in the closed state. In certain embodiments, an insert 48 adjusts the position of the accommodated computer 40 such that top surface 42 is level with upper surface 32.

Computer 40 is an electronic device for storing and processing data (typically in binary form) according to instructions given in a variable program. Computer 40 may include an interface, logic, and memory, any of which may include hardware and/or software. An interface can receive input from a user and provide output to a user; logic can execute instructions to generate output from input; and a memory can store data. Computer 40 has a top surface 42 and can be in an open or a closed state. Computer 40 may also have external ports that allow computer 40 to connect to other devices. The plurality of computers 40 may include computers 40 of the same size and/or shape or computers 40 of different sizes and/or shapes. One or more inserts 48 may be used to adjust the position of a computer 40 such that top surface 42 of computer 40 is level with upper surface 32 of horizontal platform 20.

One type of computer 40 (e.g., a laptop) may have two (or more) parts that can be moved relative to each other, e.g., the parts may be connected to each other with a hinge that allows for movement between the parts. In general, one part may have a display (e.g., a screen) and another part may have input features (e.g., keyboard, touchpad, roller ball, and/or joystick). This type of computer 40 may be in a closed state when the angle between the parts at the hinge is less than 10 degrees, such as at or approximately at zero degrees. For example, the computer may be regarded as closed, like a book. Otherwise, computer 40 may be in an open state. Another type of computer 40 may be a single part, e.g., a tablet (or slate) computer or a mobile phone (e.g., smart phone). For this type of computer 40, the closed and open states of computer 40 are equivalent. The plurality of computers 40 may include the same or different types of computers.

In certain embodiments, horizontal platform 20 supported by legs 26 may be a table. In some cases, the table may have legs 26 that rest upon a floor to support horizontal platform 20. For example, the table may have substantially vertical legs 26, as illustrated, that rest upon a floor. In other cases, the table may extend from a wall, where legs 26 may be angled supports that connect to the wall to support horizontal platform 20. In other cases, the table may be a lift table, where manual action or a mechanized motor can engage legs 26 to raise and lower horizontal platform 20.

In these embodiments, upper surface 32 of horizontal platform 20 may be the top of the table. Horizontal platform 20 may have any suitable length and width dimensions to accommodate medical device 30 and computer 40, e.g., dimensions in the range of 25 centimeters (cm) to 2 meters (m). Legs 26 may have any suitable length such that the top of the table is at a height comfortable for use by a human, e.g., a height in the range of 0.5 m to 1.5 m. Recessed portion 34 may be constructed in any suitable manner. For example, horizontal platform 20 may be cut to form recessed portion 34 or recessed portion 34 may be formed into horizontal platform 20 as horizontal platform 20 is constructed.

Recessed portion 34 of horizontal platform 20 may be of any suitable size and shape to individually accommodate each computer 40 of the plurality of computers 40. For example, recessed portion 34 may be slightly larger (e.g., 1 mm to 5 mm, 5 mm to 1 cm, or 1 cm to 2 cm larger) than the largest computer 34 of the plurality of computers 40. In certain embodiments, recessed portion 34 may have a shape and size to accommodate computer 40 as well as at least a portion of docking station 22 disposed within recessed portion 34. For example, recessed portion 34 may be slightly larger (e.g., 1 mm to 5 mm, 5 mm to 1 cm, or 1 cm to 2 cm larger) than the largest computer 34 and the portion of docking station 22 disposed within recessed portion 34.

In certain embodiments, medical device 30 is an instrument used in the diagnosis, mitigation, treatment, or prevention of disease, and which does not achieve its purpose via chemical action or metabolization within a human. For example, medical device 30 is a diagnostic instrument used in, e.g., ophthalmology, such as a topometer, biometrymeter, keratometer, lensmeter, tonometer, slit lamp, phoropter, or other medical device.

Docking station 22 is a device that can be connected to computer 40 to provide access to, e.g., a power supply, an external device (e.g., medical device 30), or a peripheral device. Docking station 22 has one or more external ports that can be connected (via cables 46 or directly) to computer 40 and/or to medical device 30. In certain embodiments, docking station 22 allows for communication between computer 40 and medical device 30, such that computer 40 can provide information (e.g., user input, motion commands, data, or instructions) to medical device 30, and/or medical device 30 can provide information (e.g., measurement results, data, or instructions) to computer 40. Computer 40 may also be connected to the internet or other computers via a network.

Docking station 22 may be disposed at least partially within recessed portion 34. For example, the portion of docking station 22 with external ports that connect to computer 40 may be disposed within recessed portion 34 to allow computer 40 better access to the ports. As another example, docking station 22 as a whole may be disposed within recessed portion 34.

Docking station 22 may individually connect to either a first computer 40 or a second computer 40 of the plurality of computers 40. In certain embodiments, apparatus 10 may connect to different types of docking stations 22. In these embodiments, a first docking station 22 may be designed to connect to one computer 40 of the plurality of computers 40, and a second docking station 22 may be designed to connect to another computer 40 of the plurality of computers 40. Docking stations 22 may have the same size and/or shape or different sizes and/or shapes. One or more inserts 48 may be used to adjust the position of a docking station 22 such that top surface 42 of the accommodated computer 40 is level with upper surface 32 of horizontal platform 20.

Cable pathway 24, located between medical device 30 and docking station 22, accommodates one or more cables 46 that connect medical device 30 and docking station 22. In certain embodiments, cable pathway 24 may be an open pathway that allows cables 46 to connect medical device 30 and docking station 22. In other embodiments, cable pathway 24 may be an enclosed or partially enclosed pathway, such as a tube, that allows cables 46 to connect medical device 30 and docking station 22. A cable 46 is one or more wires (typically covered with a plastic covering) that allows for the transmission of power or data between devices, e.g., between medical device 30, docking station 22, and computer 40. In embodiments that utilize multiple docking stations 22, cable 46 connects to one docking station 22 when another docking station 22 is not connected, e.g., after the other docking station 22 has been removed.

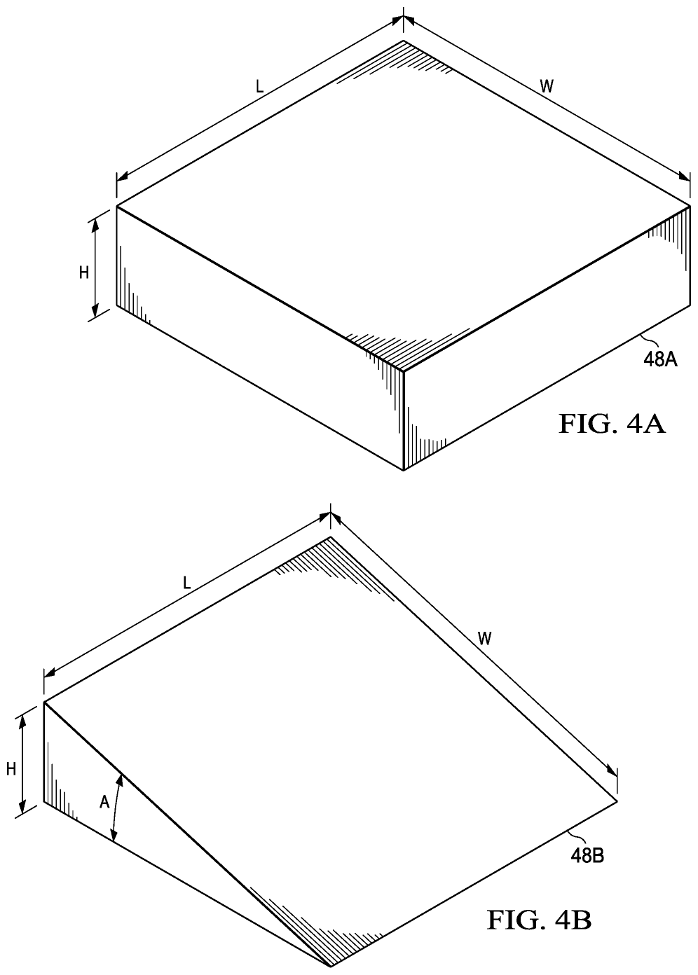

FIGS. 4A and 4B illustrate examples of an insert 48 that can be used with apparatus 10 of FIG. 1. Insert 48 may have any suitable size and shape to adjust the position of computer 40 and/or docking station 22 such that top surface 42 of computer 40 is level with upper surface 32 of horizontal platform 20. In certain embodiments, inserts 48 of a variety of shapes and sizes may be available for use with apparatus 10.

Examples of insert shapes include various types of convex polyhedrons, i.e., a polyhedron for which a line connecting any two (noncoplanar) points on the surface lies in the interior of the polyhedron. Examples of such convex polyhedrons include a rectangular cuboid (which has six rectangular faces), a wedge shape (which has three rectangular faces and two triangular faces), and a trapezoidal cuboid (which has four rectangular faces and two trapezoidal faces).

FIG. 4A illustrates an example of a rectangular cuboid insert 48a. Insert 48a has dimensions length 1, width w, and height h. The dimensions may have any suitable values. For example, length 1 and width w may be approximately (e.g., within 1 mm to 5 mm, 5 mm to 1 cm, or 1 cm to 2 cm) the size of the length and width of computer 40, or slightly smaller (e.g., 1 mm to 5 mm, 5 mm to 1 cm, or 1 cm to 2 cm smaller) than the length and width of recessed portion 34. Height h may be any height suitable for raising computer 40 and/or docking station 22 such that top surface 42 of computer 40 is level with upper surface 32 of horizontal platform 20, e.g., a value in the range of 1 mm to 1 cm, 1 cm to 2 cm, 2 cm to 3 cm, 3 cm to 4 cm, or 4 cm to 5 cm.

FIG. 4B illustrates an example of a wedge shape insert 48b. Insert 48b has dimensions length 1, width w, height h, and angle A. The dimensions may have any suitable values. For example, length 1, width w, and height h may be similar to those of insert 48a. Angle A is based on the selection of length 1, width w, and height h, and may generally have a value in the range of 1 to 10, 10 to 20, 20 to 30, or 30 to 40 degrees.

Although this disclosure has been described in terms of certain embodiments, modifications (such as substitutions, additions, alterations, or omissions) of the embodiments will be apparent to those skilled in the art. Accordingly, modifications may be made to the embodiments without departing from the scope of the invention. For example, modifications may be made to the systems and apparatuses disclosed herein. The components of the systems and apparatuses may be integrated or separated, and the operations of the systems and apparatuses may be performed by more, fewer, or other components. As another example, modifications may be made to the methods disclosed herein. The methods may include more, fewer, or other steps, and the steps may be performed in any suitable order. As used in this document, “or” as used in “x, y, or z” means one or more of {x, y, z}.

What is claimed:

1. An apparatus for accommodating a computer of a plurality of computers, comprising:
a horizontal platform supported by a plurality of legs and configured to support a medical device, the horizontal platform having an upper surface and a rectangular recessed portion;
a first docking station disposed at least partially within the rectangular recessed portion, the first docking station configured to connect to either a first computer of the plurality of computers or to a second computer of the plurality of computers, each computer of the plurality of computers having a top surface, each computer able to be in an open state or a closed state; and
a cable pathway from the medical device to the docking station, the cable pathway configured to accommodate one or more cables configured to connect the medical device to the first docking station, the rectangular recessed portion configured to accommodate either the first computer or the second computer when either the first computer or the second computer is connected to the docking station, such that the top surface of the accommodated computer is level with the upper surface of the horizontal platform when the computer is in the closed state.

2. The apparatus of claim 1, wherein the first computer and the second computer are the same size.

3. The apparatus of claim 1, wherein the first computer is of a different size than that of the second computer.

4. The apparatus of claim 1, further comprising one or more inserts, an insert configured to adjust the position of the accommodated computer such that the top surface of the accommodated computer is level with the upper surface of the horizontal platform.

5. The apparatus of claim 4, the insert having a shape selected from the group consisting of a rectangular cuboid, a wedge shape, and a trapezoidal cuboid.

6. The apparatus of claim 1, further comprising a second docking station, wherein the one or more cables are configured to connect the medical device to the second docking station when the first docking station is not connected to the one or more cables.

7. The apparatus of claim 6, wherein the first docking station and the second docking station are the same size.

8. The apparatus of claim 6, wherein the first docking station is of a different size than that of the second docking station.

9. The apparatus of claim 1, further comprising one or more inserts, an insert configured to adjust the position of the first docking station such that the top surface of the accommodated computer is level with the upper surface of the horizontal platform.

10. The apparatus of claim 1, wherein the plurality of computers comprise at least one member selected from the group consisting of a laptop, a tablet computer, and mobile phone.

11. The apparatus of claim 1, wherein:
the horizontal platform supported by the legs form a table; and
the legs rest upon a floor.

12. The apparatus of claim 1, wherein:
the horizontal platform supported by the legs form a table extending from a wall; and
the legs are angled supports that couple the horizontal platform to the wall.

13. The apparatus of claim 1, wherein:
the horizontal platform supported by the legs are part of a lift table;
manual action or a mechanized motor can engage the legs to raise or lower the horizontal platform.

14. A method for accommodating a computer of a plurality of computers, comprising:
supporting a medical device with a horizontal platform supported by a plurality of legs, the horizontal platform having an upper surface and a rectangular recessed portion;
disposing a first docking station at least partially within the rectangular recessed portion, the first docking station configured to connect to either a first computer of the plurality of computers or to a second computer of the plurality of computers, each computer of the plurality of computers having a top surface, each computer able to be in an open state or a closed state; and
accommodating one or more cables in a cable pathway from the medical device to the docking station, the one or more cables configured to connect the medical device to the first docking station, the rectangular recessed portion configured to accommodate either the first computer or the second computer when either the first computer or the second computer is connected to the docking station, such that the top surface of the accommodated computer is level with the upper surface of the horizontal platform when the computer is in the closed state.

15. The method of claim 14, further comprising adjusting the position of the accommodated computer with one or more inserts such that the top surface of the accommodated computer is level with the upper surface of the horizontal platform.

16. The method of claim 14, further comprising connecting the medical device to a second docking station via the one or more cables when the first docking station is not connected to the one or more cables.

17. The method of claim 14, further comprising adjusting the position of the first docking station with one or more inserts such that the top surface of the accommodated computer is level with the upper surface of the horizontal platform.
